(19) United States
(12) Patent Application Publication
(10) Pub. No.: US 2010/0162646 A1
(43) Pub. Date: Jul. 1, 2010

(54) Tamper-proof conduit concealing system

(76) Inventor: Gordon J. Grice, Janesville, WI (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 12/380,333

(22) Filed: Feb. 26, 2009

Related U.S. Application Data
(63) Continuation-in-part of application No. 29/313,386, filed on Dec. 30, 2008, now Pat. No. D610267.

(51) Int. Cl. E04F 17/08; H02G 3/04; E04F 19/04

(52) U.S. Cl. 52/287.1

(57) ABSTRACT

A tamper-proof conduit concealing system typically of a type typically defines an elongate solid rectangular structure, also known as a soffit. The bottommost surface of said structures is particularly prone to sagging, bowing, buckling and the like. In conduits of sufficient length, vertical surfaces are also subject to stresses and strains induced by the force of gravity. The conduit concealing system includes the provision within one or more surfaces of the soffit to be reinforced of a series of transverse ribs or gussets, that is, ribs or gussets which are perpendicular to the length of the soffit and, typically, also perpendicular to the surface to which the soffit is to be attached. Such ribs or gussets are pressure formed on the soffit and may exhibit depths in a range of 0.1 to 1.0 inches, and lengths in a range of 0.25 to 2.0 inches, as may be necessary to provide adequate stiffness to the bottom or sides of the soffit and the spacing between such ribs is generally from 10 to 30 inches along the length of the soffit.

### CROSS REFERENCE TO RELATED APPLICATION

This application is a continuation-in-part of patent application Ser. No. 29/313,386 filed on Dec. 30, 2008, which is herein incorporated by reference in its entirety.

### BACKGROUND OF THE INVENTION

All pre-fabricated metal soffit systems, as represented by said patent, have been formed of flat sheet metal into a resultant soffit having a flat bottom and usually flat side surfaces. In the case of larger width soffits, for example, 12 inches and greater, these surfaces are subject to sagging, bowing and buckling transversely to the longitudinal length or axis thereof. In some soffits, this weakness has been compensated for by the attachment of internal stiffening ribs, generally in the nature of angle irons in which the attachment is accomplished through means inclusive of welding, riveting or the use of adhesive. Such methods of stiffening of the bottom or outer walls of a soffit have proven to be time-consuming and expensive.

The present invention thereby addresses the long-felt need in the art for a metallic soffit which would not be subject to sagging, bowing or buckling transversely to its length in the manner set forth above.

The present invention represents an improvement in regard to my U.S. Pat. No. 5,526,617 (1996), entitled Tamper Proof Conduit Concealing System.

The prior art, other than my aforesaid 1996 patent, is represented by Japanese Patent No. 09119201A2 (1997), entitled Facing For Building And Storage Structure Of Building Using Facing. Said patent is assigned to Gantan Beauty Kogyo Kk. The method and structure taught by said Japanese patent (“JP 201”) is in the nature of a facing or facade intended as an external architectural section of a building such as an eave or parapet thereof and further, cannot function without the use of special-purpose brackets which are adapted to bend the facing associated with the JP201 invention into a curvature or geometry desired by a building designer. More particularly, unlike the instant invention, the JP 201 patent, while teaching the use of a form of transverse rib within an enclosure, employs ribs which span the entire transverse width thereof and, as well, such ribs possess a geometry which is complemental to recesses with brackets within the geometry of the architectural facing to be secured over such ribs and the structure associated therewith. If such ribs of the structure of JP 201 did not extend across the entire transverse width thereof and were not complemental in geometry to notches within the facing surface, it would not be functional. As such, the JP 201 patent does not use the ribs in a structure for any strengthening purpose and, as well, there is no definable bottom surface in the structure taught by the JP 201 patent. Rather, the ribs thereof are of a complete wraparound geometry having no rectilinearly definable sides of the structure related thereof.

The ribs, as above set forth, of the present inventive structure are not proportioned for connection of any type of any other constructional element. As such, the ribs, as above set forth in the present inventive structure are not proportioned for connection of any type with any other constructional element. In general, the prior art of soffits is concerned with the attachment of soffits and soffit components to each other not with the provision of means for the strengthening of any of the rectilinear surfaces of the soffit itself. The present invention addresses this long felt need in the art.

### SUMMARY OF THE INVENTION

The present invention relates to a tamper-proof conduit concealing system typically of a type defining an elongate solid rectangular structure. As above noted, the bottommost surface of such structures are particularly prone to sagging, bowing, buckling and the like. However, in conduits of sufficient length, vertical surfaces are also subject to stresses and strains induced by the force of gravity. The invention comprises the provision within one or more surfaces of a soffit to be reinforced of a series of transverse ribs or gussets, that is, ribs or gussets which are perpendicular to the length of the soffit and, typically, also perpendicular to the surface to which the soffit is to be attached. Such ribs or gussets are pressure-formed on the soffit surfaces and may exhibit depths in a range of 0.1 to 1.0 inches, and lengths in a range of 0.25 to 2.0 inches, as may be necessary to provide adequate stiffness to the bottom or sides of the soffit and the spacing between such ribs is generally from 10 to 30 inches along the length of the soffit.

It is accordingly an object of the present invention to provide an improved tamper-proof conduit concealing system having improved structural integrity over such systems as are known in the art.

It is another object to provide a conduit concealing system which is furnished with transverse reinforcing ribs or gussets.

It is a further object of the invention to provide a conduit concealing system of the above type in which more than one surfaces thereof may be reinforced by such ribs.

The above and yet other objects and advantages of the present invention will become apparent from the hereinafter set forth Detailed Description of the Invention, the Drawings, and Claims appended herewith.

### BRIEF DESCRIPTION OF THE DRAWINGS

FIG. 1 is a fragmentary view illustrative of the prior art.

FIG. 2 is a perspective view of a first embodiment of the present invention.

FIG. 2A is a perspective view of a second embodiment of the invention.

FIG. 2B is a perspective view of a third embodiment of the invention.

FIG. 4 is a top elevational view of the embodiment of FIG. 2.

FIG. 5 is a longitudinal cross-sectional view taken along Line 5-5 of FIG. 4.

FIG. 6 is a transverse cross-sectional view taken through Line 6-6 of FIG. 4.

FIG. 7 is a transverse cross-sectional view of the embodiment of FIG. 2B.

FIG. 8 is a cross-sectional view of a variant of the embodiment shown in FIGS. 2 and 6.

FIG. 9 is a variant of the embodiment shown in FIGS. 2B and 7.

FIG. 10 is a further variant of the embodiment shown in FIGS. 2 and 6.

FIG. 11 is a further variant of the embodiment shown in FIGS. 2B and 7.

FIG. 12 is a perspective of a fourth embodiment of the invention.

FIG. 13 is a vertical longitudinal cross-sectional view showing a variant of the embodiment of FIG. 5.

FIG. 14 is a perspective view of a fifth embodiment of the invention.

### DETAILED DESCRIPTION OF THE INVENTION

The present inventive improvement in a tamper-proof conduit concealing system, often termed a soffit, may be appreciated with reference to the prior art as shown in FIG. 1. Therein is shown a fragmentary view of a prior art soffit 100 which, typically, includes an inner vertical wall 102 and an outer vertical wall 104 between which is a flat bottom surface 106. In the prior art, such surfaces have found to be subject to sagging, bowing and buckling transversely to the length of the soffit, as is shown in FIG. 1. In some instances, such weaknesses have been compensated for by attaching internal stiffing ribs or angle irons attached by welding, riveting or adhesives. Use of such reinforcement means in the prior art are time consuming and expensive.

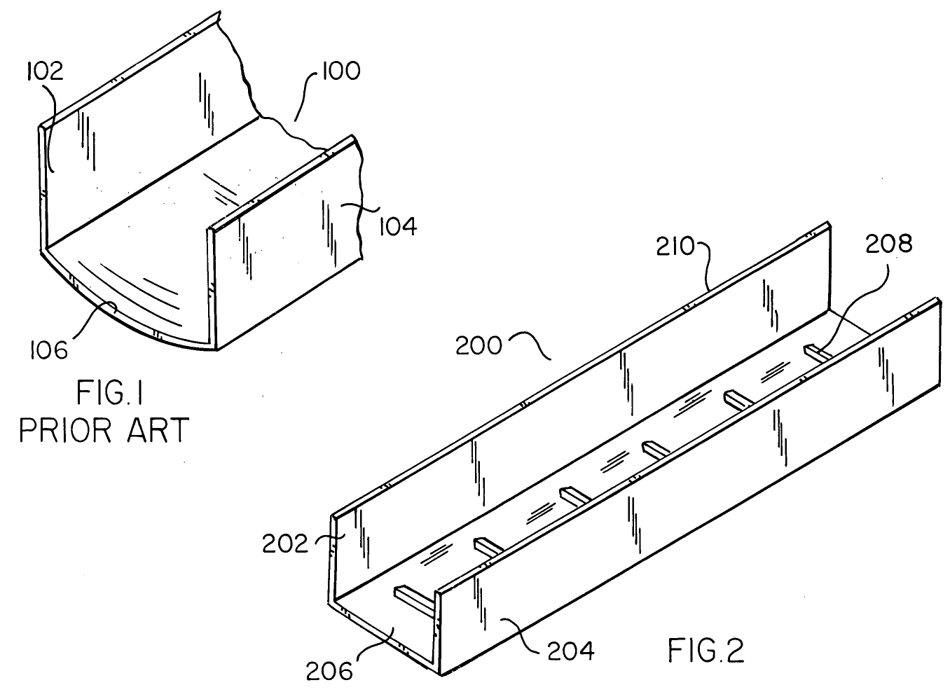

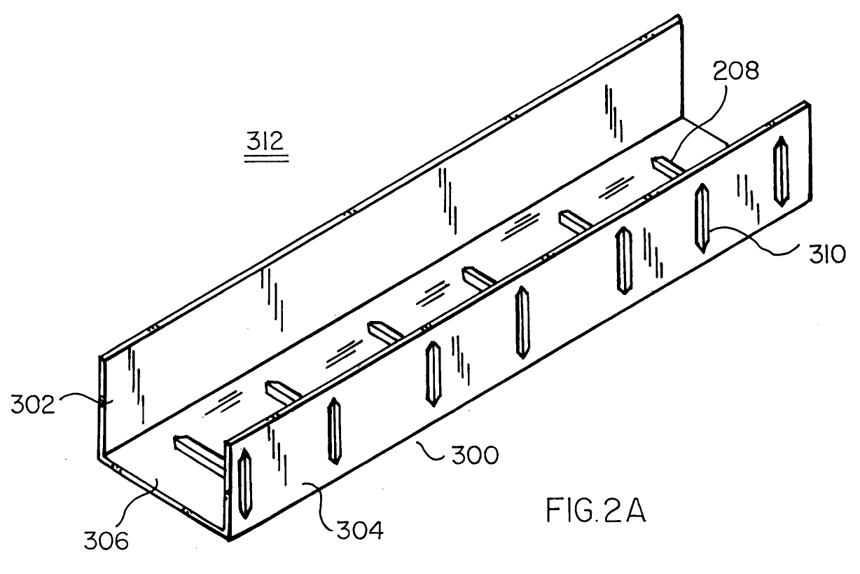

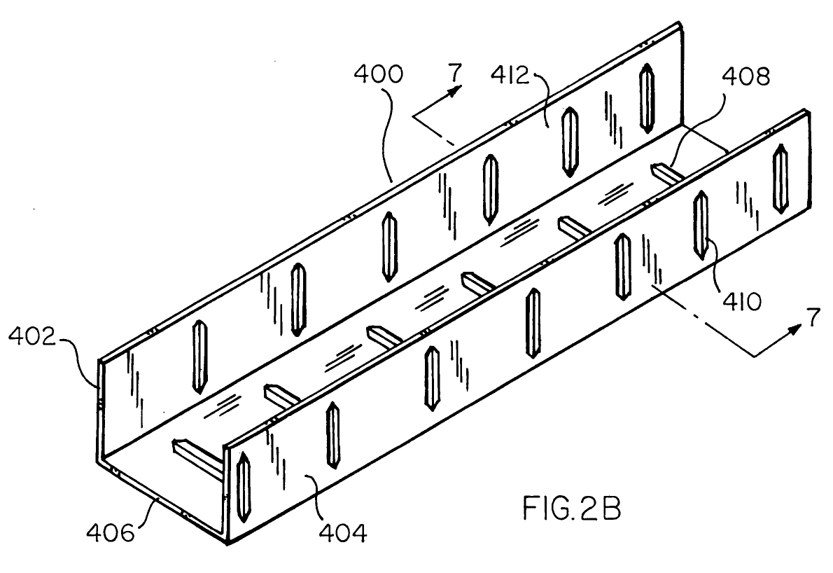

In order to avoid such sagging of flat bottom surface 106 and the cost associated with stiffing means as described above, the present invention sets forth a structure for stiffing bottom and/or sides of a given metallic soffit without the use of mechanically attached stiffening ribs. Embodiments showing the inventive solution appear in FIGS. 2 and 2A herewith. In the embodiment of FIG. 2, a soffit 200 is provided with transverse stiffing ribs or gussets 208. Accordingly, in the soffit of the type shown in FIG. 2, rear and front sidewalls 202 and 204 are similar to those of the prior art, however, bottom surface 206 is provided with a plurality of said integrally formed ribs 208 which, however, do not extend to the walls 202 or 204. It is to be appreciated that such ribs may be formed by application of pressure tooling from either above or below the surface 206 of the gusset 200, typically at a pressure of several tons.

In FIG. 2A is shown a further embodiment of the present invention, namely, soffit 300, in which both bottom surface 306 and front sidewall 304 are provided with transverse gussets 208 and 310 respectively. In one form of this embodiment, the transverse plane of vertical ribs 310 is offset relative to the transverse of horizontal ribs 208 of bottom surface 306. In this embodiment, inner surface 302 is not provided with any reinforcing ribs. It is to be appreciated that such ribs, as below described, may be provided in various cross-sectional geometries as to provide appearances that may be specifically desired for a given facility. See for example, FIG. 5 which shows a triangular vertical cross-section and FIG. 13 which shows a semi-circular cross-sectional geometry. Further geometries may include square and rectangular cross-sections to the ribs employed in any of the embodiments set forth herein.

In FIG. 2B is shown a further embodiment of the instant invention, namely, soffit 400, in which all three surfaces, that is, surfaces 402, 404 and 406 are provided with transverse ribs 412, 410 and 408 respectively. This embodiment would have particular applications where the soffit is freestanding relative to a wall, as opposed to the gusset 300 of the embodiment of FIG. 2 or 2A

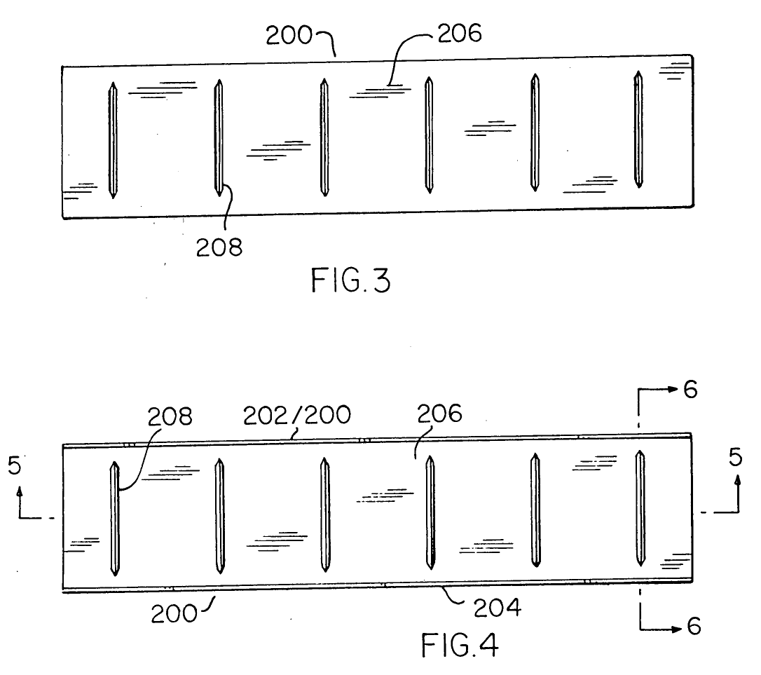

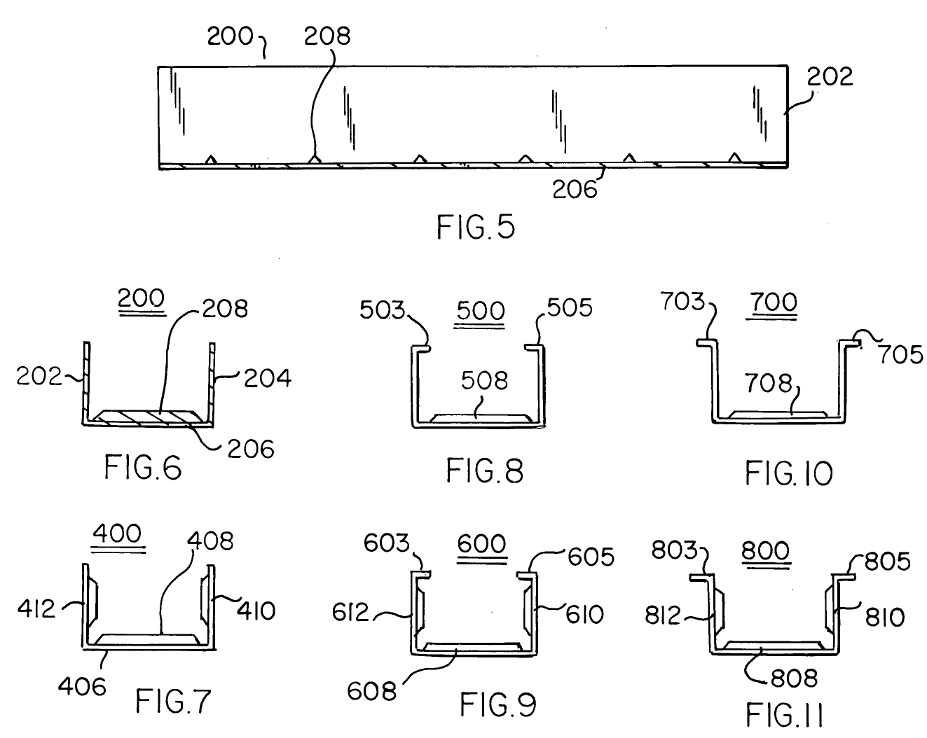

FIG. 3 is a bottom view of the embodiment of FIG. 2, while FIG. 4 is a top view of said embodiment. FIG. 5 is the cross sectional view taken along Line 5-5 of FIG. 4 showing the above-described triangular geometry of ribs 208, while FIG. 6 is a transverse cross-sectional view taken through Line 6-6 of FIG. 4. In said FIG. 6, may be seen transverse rib 208 formed within bottom surface 206 as well as perspective side surfaces 202 and 204 of gusset 200 of the embodiment of FIG. 2.

In FIG. 7 is shown a transverse vertical cross-sectional view taken along Line 7-7 of FIG. 2B. Therein may be seen horizontal rib 408 as well as vertical ribs 410 and 412 of soffit 400.

Shown in FIG. 8 is a vertical cross-sectional view of a variation of the embodiment of FIG. 2, namely, soffit 500, in which the upper edges of thereof are provided with inward turned tabs 503 and 505 for use in those situations where use of such tabs to apply fasteners to facilitate securement of the soffit to a surface of interest would prove helpful.

FIG. 9 shows a further embodiment, namely soffit 600, similar to the embodiment 500 described above in which inward turned tabs 603 and 605 are provided at the uppermost edges which depend from walls 612 and 610 respectively of the soffit for use in an embodiment corresponding to soffit 400 of FIG. 2B as described above.

In FIG. 10 is shown a further embodiment, namely, soffit 700, generally corresponding to soffit 200 above however in which the upper longitudinal edges of the soffit are provided with outwardly directed tabs 703 and 705 for use where outwardly directed tabs would be of more utility than inwardly directed tabs in accomplishing securement of the soffit 700 to a ceiling or other surface.

Correspondingly, FIG. 11 shows a yet further embodiment, namely soffit 800, corresponding generally to soffit 400 as above described in which however the upper longitudinal edges of the soffit are provided with outwardly directed tabs 803 and 805, in which such tabs would be more helpful than inward tabs in securement, development from walls 812 and 810 respectively to a surface or other surface.

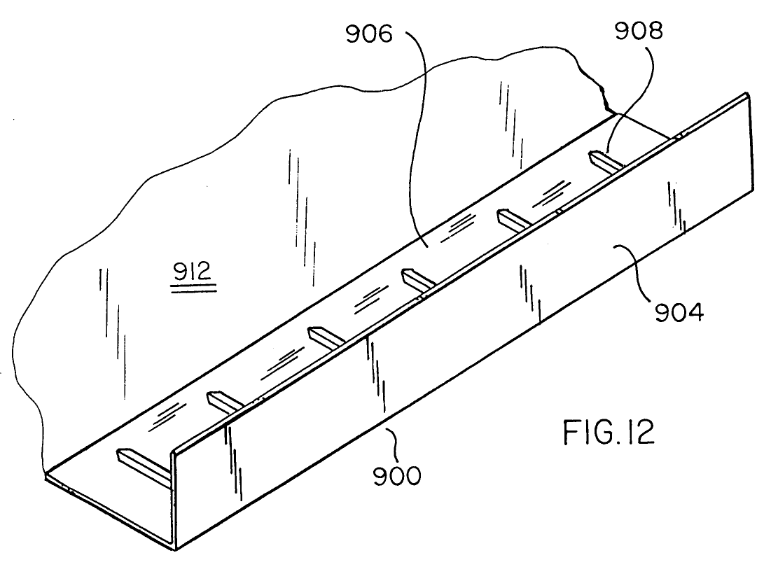

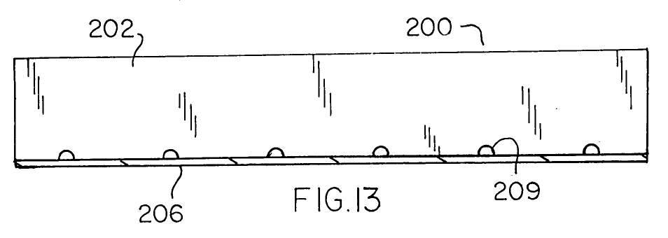

With reference to FIG. 12, there is shown a further embodiment of the invention, namely soffit 900, generally corresponding to soffit 200 of FIG. 2 above, in which the soffit however consists of only a bottom surface 906 and a side surface 904 in which the bottom surface is secured to a wall 912 or other constructional surface.

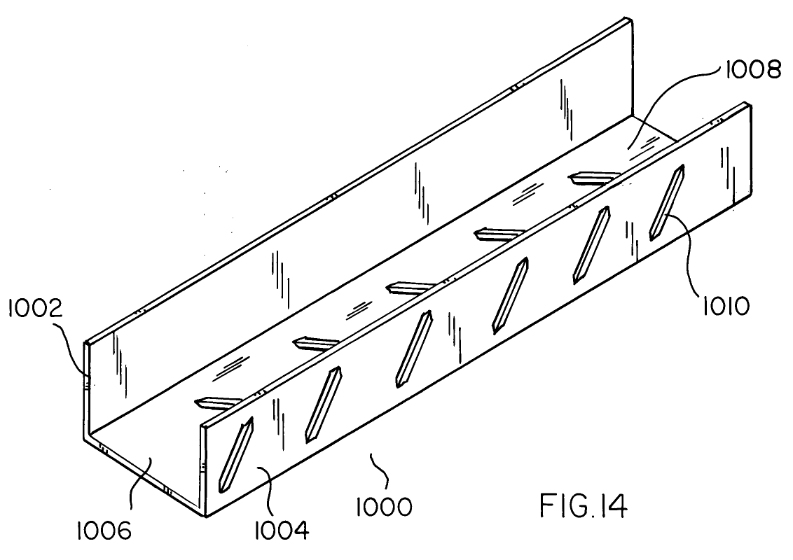

In FIG. 14 is shown a further embodiment of the invention, namely, soffit 1000, generally corresponding to embodiment 300 above-described in FIG. 2A however in which the ribs are oriented diagonally to a transverse cross-section of the soffit. Therein, diagonal ribs 1008 are provided upon bottom surface 1006 and diagonal ribs 1010, preferably having an opposite direction of tilt to that of ribs 1008, are provided upon outer vertical surface 1004 of the structure. Inner surface 1002 is not provided with ribs in that it is contemplated that said surface would be appropriately secured to a wall or other constructional surfaces. It is to be appreciated that through the use of diagonal ribs such as ribs 1008 and 1010 of soffit 1000, truss-like resistance to stresses, strains, pressure, bending moments and the like, typically experienced by soffits, can be provided to thereby enhance structural integrity.

The various ribs as above set forth may have lengths in a range of about 0.25 to 2.0 inches, and a depth of about 0.1 to 1.0 inches.

It is to be appreciated that in all embodiments of the invention, the ribs or gussets thereof do not extend across the entire transverse width of the surface within which they are formed, and may even be segmented. This is in distinction to Japanese Patent Application 091192021 A2 (1997), referenced in the Background of the Invention above, in which the transverse ribs thereof must extend across the entire width of each surface re-inforced and can only function complementally with external recesses that are a part of an architectural treatment of a building.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

Having thus described my invention, what I claim as new, useful and non-obvious and, accordingly, secure by Letters Patent of the United States is:

1. An elongate tamper-proof conduit concealing system having rectilinear surfaces or walls, the system comprising:
ribs extending transversely to a longitudinal axis of the walls, thereof, said ribs extending transversely between walls of the soffit adjacent to the wall, but not touching any contiguous surface or wall other than the wall or surface provided with said ribs.

2. The conduit concealing system as recited in claim 1, in which a bottom wall of the system is reinforced by said transverse ribs.

3. The conduit concealing system as recited in claim 1, in which one or more of said surfaces of the system are so reinforced.

4. The conduit concealing system as recited in claim 1, in which the length of said ribs falls in a range of about 0.25 to about 2.0 inches.

5. The conduit concealing system as recited in claim 1, in which a depth of said ribs falls in a range of about 0.1 to about 1.0 inches.

6. The conduit concealing system as recited in claim 1, in which said ribs, in cross-sectional geometry, define a triangle.

7. The conduit concealing system as recited in claim 1, in which said ribs, the cross-sectional geometry, define a semi-circle.

8. The conduit concealing system as recited in claim 1, in which said ribs, in cross-sectional geometry, define a rectangle.

9. The system as recited in claim 1, in which said ribs, in cross-sectional geometry, define a square.

10. The conduit concealing system as recited in claim 1, in which said ribs are disposed at spacing intervals in a range from about 10 to about 30 inches along the length of the soffit.

11. An elongate tamper-proof conduit concealing system having rectilinear surfaces or walls, the system comprising:
ribs extending transversely to a longitudinal axis of the walls, thereof, said ribs extending diagonally between walls of the soffit adjacent to the wall, but not touching any contiguous surface or wall other than the wall or surface provided with said ribs.

12. The conduit concealing system as recited in claim 11, in which a bottom wall of the system is reinforced by said diagonal ribs.

13. The conduit concealing system as recited in claim 11, in which one or more of said surfaces of the system are so reinforced.
